(19) United States
(12) Patent Application Publication
(10) Pub. No.: US 2022/0021555 A1
(43) Pub. Date: Jan. 20, 2022

(54) DECENTRALISED COMMUNICATION SYSTEM AND CORRESPONDING CONTROL METHOD

(71) Applicant: LUOS ROBOTICS, Le Bouscat (FR)

(72) Inventors: Jonathan Grizou, Mauroux (FR); Matthieu Lapeyre, Bordeaux (FR); Nicolas Rabault, Bordeaux (FR); Pierre Rouanet, Bordeaux (FR)

(73) Assignee: LUOS ROBOTICS, Le Bouscat (FR)

(21) Appl. No.: 17/413,336

(22) PCT Filed: Jun. 21, 2019
(86) PCT No.: PCT/FR2019/051521

§ 371 Date: Jun. 11, 2021

(51) Int. Cl. H04L 12/407; H04L 12/751; H04L 12/741

(52) U.S. Cl. CPC H04L 12/407; H04L 2012/4026; H04L 45/74; H04L 45/02

(57) ABSTRACT

Decentralised communication system comprising at least two modules, each module being connected to at least one neighbouring module by a point-to-point connection (3a), all the modules being connected to each other by at least one series connection (3b), each module being selected from an interface module (2) or a communication module (4), an interface module (2) being connected to at least one memory (5), a communication module (4) being connected to at least one device (7), a device (7) being selected from an actuator, a sensor, a communication means, a memory, a battery, a power supply or a data-processing medium.

The technical field of the invention is communication buses and more specifically buses for communicating between electronic devices.

Current complex systems involve controlling actuator, sensor, emitter, battery, memory power supply, or computer type devices, and allowing them to communicate with each other.

The density of components and the electromagnetic disturbances generated by these various devices make it necessary to use a communication bus resistant to noisy environments.

The devices that allow synchronised and rapid device responses make it necessary to use a low latency and congestion resistant communication bus. Likewise, failure detection is necessary in order to effectively determine the malfunction of a device among the multitude installed.

Power saving and in-flight connection/reconnection of devices requires advanced topology detection and addressing capabilities from the communication bus allowing to identify and address each device during its connection or the recovery of its power supply.

In order to allow easy deployment, the communication bus must require little calculation time and have a limited space requirement.

Several communication buses have been developed in different industrial environments in order to meet specific throughput, fault resistance or latency needs.

The following communication buses are known from the prior art.

The I2C bus (acronym for “Inter-Integrated Circuits”) is a bidirectional half-duplex synchronous serial bus, based on two conductors. It is a light bus dedicated to electronics, with a master-slave structure and can have several masters on the same bus. Its main drawback is that it has a low communication speed and is not immune to electromagnetic interference. This bus does not allow automatic address assignment or detection of the network topology.

The CAN (acronym for “Controller Area Network”) bus is a bidirectional half-duplex serial bus, developed by and for the automotive industry, highly immune to noise and reliable and based on two twisted conductors. This bus has a low communication speed associated, however, with low latency. It is subject to congestion in the event of an error in order to detect and isolate the anomaly. This bus does not allow topology detection.

The Ethercat (acronym for “Ethernet for Control Automation Technology”) bus is a communication bus for the automation of industrial installations, based on an Ethernet type layer. This bus allows very high communication speed associated with low latency while being well immune against noise. It also allows topology detection, however limited to a star topology. Its main drawbacks are a very expensive implementation as well as a complex use.

It thus appears that none of these buses allows to provide communication capabilities as identified in the introduction.

The object of the invention is a decentralised communication system in a robot comprising at least two modules, each module being connected to at least one neighbouring module by a point-to-point connection, all the modules being connected to each other by at least one series connection, each module being selected from at least one interface module or one communication module, an interface module being connected by a connection other than the series connection or the point-to-point connection to at least one memory allowing communication between the memory and the at least one other module, a communication module being connected by a connection other than the series connection or the point-to-point connection to at least one device allowing communication between the at least one device and the at least one other module, a device being selected from at least one actuator, a sensor, a communication means, a battery, a power supply or a data processing means.

Each module can comprise at least two first communication means each capable of being connected to a point-to-point connection and at least one series communication means connected to a series connection, the communication means being connected to at least one data processing means.

A module can be a coordination or switching module configured to connect at least three modules in parallel, each module being connected by a point-to-point connection and a series connection,

the coordination module being configured to retransmit predefined values received over a point-to-point connection according to predefined rules,

the switching module being configured to retransmit messages received over a series connection to at least one other series connection and predefined values received over a point-to-point connection to at least one other point-to-point connection according to predefined rules.

The invention also relates to a method for controlling a decentralised communication system according to any one of the preceding claims, wherein the communication system comprises a first module and at least a second module connected to the first module,

at least one message is transmitted comprising a preamble and a header between at least two modules of the communication system by carrying out the following steps:

the series communication means of the first module is controlled so as to activate its emission mode while keeping the reception mode activated,

the first module is controlled so as to emit the preamble and at least part of the header via the series connection,

the series communication means of each second module is controlled so as to prohibit the emission mode upon reading at least part of the header,

it is determined via the first module whether another message is emitted by a series communication means of at least a second module in a time interval comprised between the start of the emission of the preamble and the end of the emission the header,

if this is the case, it is considered that the message must not be read by the at least a second module and must be re-emitted by the first module,

if this is not the case, the first module is controlled so as to emit the rest of the message via the series connection,

when the entire message is transmitted, the series communication means of the first module is controlled so as to activate its reception mode and deactivate its emission mode and the series communication means of each second module is controlled so as to cancel the prohibition of the emission mode.

A message can also comprise at least one of the data and an error check value.

It is possible to gradually carry out a neighbour detection in order to discover at least a second module connected directly or indirectly to a first module and it is possible to assign at least one routing address to each second module connected directly or indirectly to the first module, by carrying out the following steps:

a first routing address is assigned to the first module, then

for each point-to-point connection connected to the first module, the following steps are carried out: each module connected directly or indirectly to the first module is controlled, one after the other, so that it performs at least one neighbour detection through the series connection and a point-to-point connection, each time a neighbour is detected, the detected neighbour module is controlled so that it confirms its presence to the first module via the point-to-point connections, the first module is controlled so that it emits at least one new routing address via the series connection, the neighbouring module is controlled so that it stores the at least one new routing address, and the neighbouring module is controlled so that it performs, in turn, a neighbour detection, the detection of neighbours is stopped when none of the modules connected directly or indirectly detects a new neighbour.

A neighbour detection can be carried out gradually in order to discover at least a second module connected directly or indirectly to a first module, by carrying out the following steps:

for each point-to-point connection connected to the first module, the following steps are carried out:

each module connected directly or indirectly to the first module, one after the other, is controlled so that it performs at least one neighbour detection via the series connection and a point-to-point connection,

at each detection of a neighbour, the detected neighbour module is controlled so that it confirms its presence to the first module via the point-to-point connections, and the neighbouring module is controlled so that it performs, in turn, a neighbour detection,

the detection of neighbours is stopped when none of the modules connected directly or indirectly detects a new neighbour.

When a module is connected to at least two devices, the neighbour discovery step can be repeated for each device connected to the module.

To carry out a neighbour detection by a module having received a first predetermined value by a first point-to-point communication means, the following steps can be carried out:

the emission of a first predefined value is controlled by the second point-to-point communication means of the module on the point-to-point connection,

it is determined whether the module receives a predefined value in return by the second point-to-point communication means, for a predetermined duration starting at the instant of emission of the first predefined value by the second point-to-point communication means,

if this is the case and the predefined value is equal to the first predefined value, a neighbouring module is considered to be connected to the other end of the point-to-point connection connected to the module,

if this is not the case, it is considered that no second module is connected to the other end of the point-to-point connection connected to the second point-to-point communication means of the module, and a second predefined value is emitted by the first point-to-point communication means.

To confirm its presence to the first module, a module can transmit a first predefined value by its first point-to-point communication means, the first predefined value being retransmitted gradually through the modules and point-to-point connections to the first module

A module being connected to a first point-to-point connection and to a second point-to-point connection, when the module has emitted a first value by the first point-to-point connection within a predefined duration, the module receives a first predefined value by the second point-to-point connection within the predefined duration, it can retransmit the first predefined value by the first point-to-point connection.

A module being connected to a first point-to-point connection and to a second point-to-point connection, when the module has emitted a first value by the first point-to-point connection within a predefined duration, the module receives a second predefined value by the second point-to-point connection within the predefined duration, it can retransmit the second predefined value by the first point-to-point connection.

When the module is a coordination or switching module, comprising a first point-to-point communication means and at least two second first communication means,

the communication or coordination module can be controlled so as to carry out a routing and neighbour detection address assignment for each second point-to-point communication means, the coordination or switching module changing from the second point-to-point communication means upon receiving a second predefined value by the second point-to-point communication means, and,

when the coordination or switching module has received a second predefined value on each of its second first communication means, it can transmit the second predefined value by its first point-to-point communication means.

It can be determined that none of the modules connected directly or indirectly to the first module detects a new neighbour, when the first module receives a second predefined value via the point-to-point connection through which it has emitted the first predefined value.

When a detection of neighbours and an addressing of the discovered modules are controlled by a first module, then, when a subsequent detection of neighbours is controlled by the first module,

the last module discovered during the subsequent detection of neighbours can be compared with the last module discovered during the initial detection of neighbours and the addressing of the modules,

it can then be determined whether the last module discovered during the subsequent detection of neighbours is different from the last module discovered during the initial detection of neighbours and the addressing of the modules.

Other purposes, features and advantages of the invention will become apparent upon reading the following description, given only by way of non-limiting example and made with reference to the appended drawings wherein:

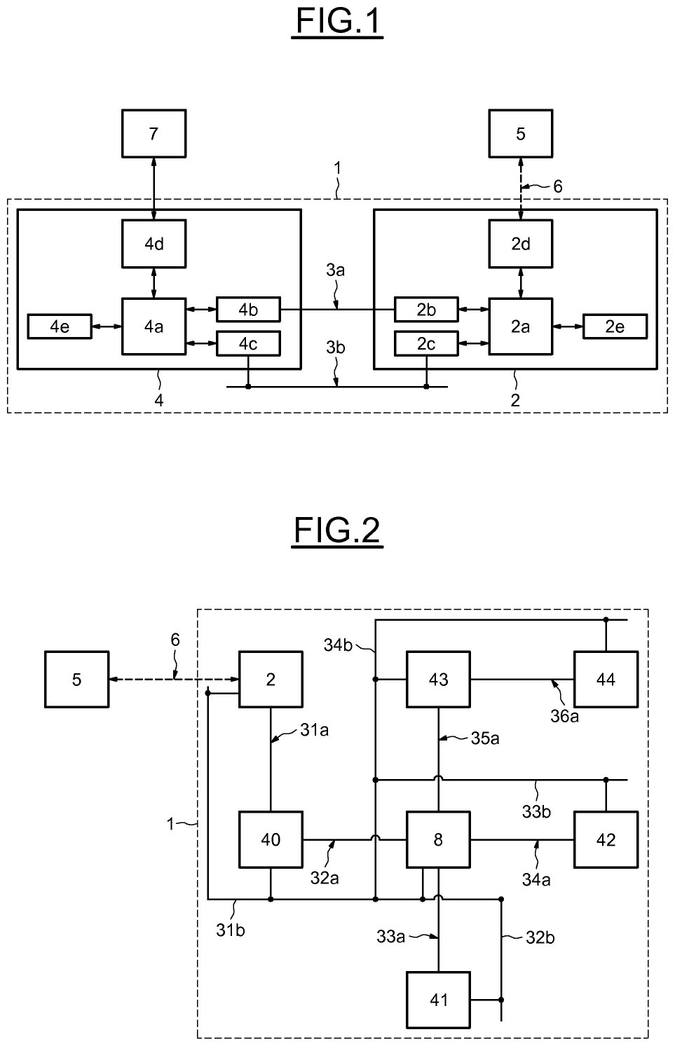

FIG. 1 illustrates the decentralised communication system according to a first embodiment, and

FIG. 2 illustrates the decentralised communication system according to a second embodiment.

The decentralised communication system comprises at least two modules each selected from an interface module, a communication module, a coordination module and a switching module, connected in a network.

The decentralised communication system is controlled by a decentralised communication method ensuring the communication of messages between the modules according to different communication modes, the discovery of the connected modules, and the assignment of routing addresses to each discovered module.

FIG. 1 shows the decentralised communication system comprising an interface module 2 connected to a communication module 4 by a point-to-point PTP connection referenced 3a and by a series connection 3b, moreover the communication module 4 being connected directly or indirectly to at least one device 7 of a complex system, in particular of a robot.

The interface module 2 is also connected directly or indirectly to at least one memory 5 comprising instructions or data exchanged with at least one of the connected modules.

The interface module 2 comprises a data processing means 2a, such as a microcontroller, configured to interact with two first communication means 2b, 2e, a series of communication means 2c, and at least a third communication means 2d.

The first two communication means 2b, 2e are each capable of being connected to a point-to-point connection. In FIG. 1, a single point-to-point communication means, referenced 2b, is connected to a point-to-point connection 3a.

The series communication means 2c is connected to the series connection 3b.

The first and second communication means 2b, 2c allow the exchange of data between the interface module 2 and, respectively, a point-to-point communication means 4b and a series communication means 4c of the communication module 4.

The series communication means 2c comprises an independent emission mode and a reception mode. Thus each mode can be activated or deactivated independently of the activation state of the other mode.

A third communication means 2d allows the exchange of data between the interface module 2 and the at least one memory 5 through a connection 6 of a first type, in particular ethernet, Wi-Fi or Bluetooth, and possibly through a remote server.

The data processing means 2a comprises a microprocessor or microcontroller as well as optionally at least one memory.

The data processing means 2a can be configured to control the transmission, with or without prior processing, of all or part of the data received from the first and second communication means 2b, 2c, 2e via the third communication means 2d to the memory 5.

The data processing means 2a can be configured to control the reception of data by the third communication means 2d, to process them according to data received from the point-to-point connection 3a and to the series connection 3b via the first and second communication means 2b, 2c, 2e.

The data processing means 2a can also be configured to control the transmission, with or without prior processing, of all or part of the data received from the third communication means 2d through the first and second communication means 2b, 2c, 2e to the communication module 4.

The person skilled in the art will understand that the data processing means comprise all or part of the features described above, said features being activated or deactivated according to the instructions or the results of processing the data received.

The point-to-point connection 3a comprises at least one wire. In one embodiment, the point-to-point connection can be protected against noise using a differential or validation signal.

The differential signal involves a difference in signals between at least two wires of the point-to-point connection 3a.

The validation signal comprises both a signal sent by at least one wire of the point-to-point connection 3a and a validation signal transmitted by the series connection 3b. The signal sent on the point-to-point connection 3a is only validated when the validating signal is received simultaneously or within a predetermined duration relative to the instant of reception of the message on the point-to-point connection 3a.

The series connection 3b also comprises at least one wire. In another embodiment, the series connection can comprise at least one pair of twisted wires, in particular of the RS485 type. In a particular embodiment, two electrical power supply wires can be arranged in parallel with the series connection 3b in order to centrally power the different connected modules.

Wire means both a connection with a physical connector and an integrated connection within a printed or integrated circuit. It can also be a software connection between software modules.

As can be seen in FIG. 1, a communication module 4 has a structure similar to that of the interface module 2.

The communication module 4 comprises a data processing means 4a, such as a microcontroller, configured to interact with the communication means 4b, 4c, 4d, 4e.

The data processing means 4a comprises a microprocessor or microcontroller as well as optionally at least one memory.

The communication module 4 comprises two first communication means 4b, 4e each capable of being connected to a point-to-point connection and a series communication means 4c connected to the series connection 3b.

The point-to-point communication means 4b is connected to the point-to-point connection 3a.

The point-to-point communication means 4b and the series communication means 4c allow the exchange of data between the communication module 4 and the interface module 2 via the point-to-point connection 3a and the series connection 3b respectively.

The series communication means 4c comprises an independent emission mode and reception mode. Thus each mode can be activated or deactivated independently of the activation state of the other mode.

The communication module 4 comprises at least a third communication means 4d configured to exchange data with a device 7. The communication module 4 can thus exchange data with several devices 7. In such a case, the data processing means 4a can be configured to receive data from a first device and transfer them, with or without processing, to a second device, the first and second devices being connected to the communication module 4.

The data processing means 4a can also be configured to control the transmission, with or without prior processing, of all or part of the data received from the third communication means 4d via the first and second communication means 4b, 4c, 4e to the communication module 4.

The data processing means 4a can also be configured to control the transmission, with or without prior processing, of all or part of the data received from the first and second communication means 4b, 4c, 4e via the third communication means 4d to the devices 7 connected to the communication module 4.

FIG. 2 shows the decentralised communication system 1 according to the invention comprising a larger number of modules.

The person skilled in the art will easily understand that the number of modules of the decentralised communication system 1 is adapted for the size and the functions of the complex system. It follows that the architecture shown in FIG. 2 is only an example of architecture and that other architectures and arrangements of modules are possible and within the scope of this description.

Each communication module 40, 41, 42, 43, 44 comprises a structure similar to that of the communication module 4 illustrated in FIG. 1. They comprise at least one data processing means connected to two first communication means each capable of being connected to a point-to-point connection and to a series communication means connected to the series connection. Each communication module 40, 41, 42, 43, 44 also comprises at least a third communication means connected to a device. For the sake of clarity, the first, second and third communication means as well as the devices are not illustrated in FIG. 2.

Moreover, the point-to-point connections 31a, 32a, 33a, 34a, 35a, 36a and the series connections 31b, 32b, 33b, 34b each comprise a structure similar respectively to those of the point-to-point 3a and series 3b connections of FIG. 1.

However, some device configurations may require a parallel configuration, also known as a star configuration. To achieve this, use is made of a coordination module. FIG. 2 shows such a coordination module referenced 8 configured to connect several communication modules 40, 41, 42, 43, 44 in parallel.

Such a coordination module 8 comprises a data processing means, at least three first communication means and a second communication means. It differs from communication and interface modules in that it is not connected to a device or memory.

In FIG. 2, it can also be seen that the coordination module 8 is connected to the interface module 2 by the series connection 31b. The series connection 31b propagates to the modules connected behind the coordination module 8 through series connections 32b, 33b, 34b each defining a branch of the star configuration.

The messages emitted on the series connection 31b thus pass through each branch of the star configuration. Thus, all the modules connected to the coordination module 8 receive messages via the series connection to which they are connected, in a similar way to the reception of messages by the modules connected before the coordination module 8.

The coordination module 8 selectively duplicates the messages received on the point-to-point connection 32a to the other point-to-point connections 33a, 34a, 35a to which it is connected. However, the duplication of these messages depends on the operation step.

The data processing means of the coordination module is thus configured to transmit, with or without processing, all or part of the data received from the first and second communication means via other first and second communication means respectively.

In other words, the coordination module 8 does not allow to ensure direct communication with a device but rather transmits the data exchanged between the modules of the decentralised communication system 1.

Moreover, a module can be a switching module, not illustrated in FIGS. 1 and 2, having a structure similar to the coordination module 8. It comprises at least three second communication means, each connected to a separate series connection. The coordination module 8 duplicates the messages received by the series connection 31b on each branch of the star configuration. However, the duplication of these messages depends on the operation step.

However, a switching module behaves similarly to the coordination module during the neighbour discovery steps.

The different steps of a method for controlling the decentralised communication system 1 will now be described.

In order to be able to communicate the different connected modules within the decentralised communication system through message exchanges, several steps are necessary.

The structure of the messages exchanged between modules will now be described.

A message exchanged between two modules comprises a preamble P, a header H, and data D. In a particular embodiment, it comprises an error check value CTRL.

The preamble P is used to trigger the reception or transmission of a new message. In one embodiment, the preamble P is a period of inactivity of the decentralised communication system 1 between each message. Receiving the preamble allows to reset the status of a module so that it can receive a new message or erase a false message.

The header H comprises several fields containing information allowing a module to understand the message.

The header H comprises a version number field, a target field, a target mode field, a source field, a control field, and a size field.

The version number field defines the version number of the communication method used to establish the exchanged message. The version number field allows a module to determine how to read the message. The target field indicates a routing address of the module to which the message is intended. It should be noted that in the case where several devices are connected to a communication module, a routing address can be assigned to the communication module for each connected device. Thus, the communication module can have several routing addresses.

The target mode field indicates the addressing mode and how to interpret the target field.

A first addressing mode is the ID mode during which the message is intended for a single module identified by its routing address and without acknowledgement of receipt.

A second addressing mode is the ID+ACK mode during which the message is intended for a single module identified by its routing address and with acknowledgement of receipt.

A third addressing mode is the Broadcast mode during which the message is transmitted to all the modules connected to the series connection. In such an addressing mode, the target field is not considered by the modules reading the message.

In one embodiment, provision is made of a fourth addressing mode called Type mode during which the message is transmitted to all the modules of a defined type. Each module comprises a Type address depending on the nature of the devices connected thereto. For example, all engines can be given type 1 address, all light sources can be given type 2 address, and all sensors can be given type 3 address. In the context of this example, a message with the type 2 address then targets all light sources connected to the communication system. The source field indicates the routing address of the module from which the message is originated.

The control field defines the type of data transmitted.

The size field indicates the size of the data comprised in the message.

The data D correspond to the main part of the message comprising the data exchanged.

The error check value CTRL is used to determine the presence of an error upon receiving the message by comparing the error check value CTRL comprised in the message to the error check value determined upon reception, both values being determined by applying predetermined mathematical functions to the digital values associated with the header H and with the data D. The error check value may in particular be a cyclic redundancy check value CRC or a checksum.

In a particular embodiment, the message also comprises an acknowledgement of receipt A. In one embodiment, the acknowledgement of receipt can take two distinct values, a first value being associated with the message sent from the source to the target, the second value being associated with the acknowledgement of receipt sent from the target to the source. This field is used in conjunction with the second ID+ACK addressing mode.

The step of transmitting a message between two modules will now be described.

When controlling the emission of a message by a first module, the first module is controlled so as to activate the emission mode of the series communication means while keeping the reception mode activated.

This allows the first module to detect any collision errors during the transmission of the header H. It is defined that a collision is the emission of a message by two distinct modules on the series connection within a predefined time interval, comprised between the start of the emission of the preamble and the end of the emission of the header. In order to avoid misdetections, it is considered that the time interval is preferably equal to the duration of emission of the preamble and of the at least a first bit of the header.

The first module is controlled so as to emit the preamble or to wait for the duration of the preamble according to the embodiment.

If no message collision is detected, the first module is then controlled so as to emit the header H of a message via the series connection. A message or part of a message emitted on the series connection is read by all the modules connected to the series connection. Each module receiving the message interprets the content of the message according to its features (routing address, type address, etc.) and to the structure of the message described above.

Upon receiving the header H, the second module reads the header H of the message, and controls its series communication means so that the emission mode is prohibited. In other words, emitting the header H by one module controls the other modules receiving the header H by their series connection, so that they cannot, in turn, emit a header.

The emission of the rest of the message is then controlled.

When the entire message is transmitted, the series communication means of the first module is controlled so as to activate the reception mode and deactivate the emission mode and the series communication means of the second module is controlled so as to deactivate the prohibition of the emission.

In other words, after emitting the message, the connected modules return to their default state.

Moreover, the person skilled in the art will appreciate that the message exchange method described above allows a module emitting a message to take control of the series communication means of other connected modules. Such control acquisition allows to avoid network congestion and poor quality of service QoS (acronym for “Quality of Service”).

The neighbour detection step will now be described in relation to FIG. 1.

When a communication module 4 is connected to the interface module 2, it is not discovered and does not have a routing address.

In order to be able to exchange messages requiring a routing address, step-by-step discovery is initiated from the interface module 2.

It should be noted that by default all the connected modules have the reception mode of their series communication means 2b activated.

To carry out this step, the first routing address of the decentralised communication system referenced 1 is assigned to the interface module 2. Then, the activation of the emission mode of the series communication means 2b of the interface module 2 is controlled in the emission mode and a first predefined value on the point-to-point connection 3a is emitted by the interface module 2. In the case where the first module is connected to two point-to-point connections, the detection step is repeated for each point-to-point connection.

A module connected to the point-to-point connection 3a receives the first predefined value, and returns, in return, this same first predefined value.

When the interface module 2 receives the first predefined value in return via the point-to-point connection 3a, a new routing address to be assigned is determined.

A message in broadcast mode comprising the new routing address to be assigned is then emitted via the series communication means 2c of the interface module 2.

Since this message is emitted on the series connection 3b, it is read by each of the connected modules, regardless of their discovery by the interface module 2.

A module receiving both the message in broadcast mode comprising the new routing address to be assigned by the series connection, and having emitted the first predefined value on a point-to-point connection connected to its first point-to-point communication means and perceiving a second predefined value on its second point-to-point communication means, records the routing address to be assigned. Then, it emits the first predefined value through the point-to-point connection connected to its second point-to-point communication means to continue discovering the network. If another module is connected to the other end of the point-to-point connection connected to its second point-to-point communication means, it receives in return the first predefined value, and re-emits in return the first predefined value via the point-to-point connection connected to the interface module 2. The interface module 2 deduces from this that there are still modules to be discovered and addressed. The interface module 2 then generates and emits another routing address.

If no other module is connected to the other end of the point-to-point connection connected to its second point-to-point communication means, it does not receive the first predefined value in return. Then, it re-emits a second predefined value via the point-to-point connection connected to interface module 2 in return.

The interface module 2 deduces from this that there are no modules left to discover and address. The interface module 2 then stops generating new routing addresses.

In the case illustrated in FIG. 1, the interface module 2 emits the first predefined value through the point-to-point connection 3a. The communication module 4 receives the first predefined value via the point-to-point connection 3a and re-emits the first predefined value in return via the point-to-point connection 3a.

When it receives the first predefined value via the point-to-point connection 3a, the interface module 2 deduces from this that a module is connected. A second routing address is generated, and the interface module 2 emits in broadcast mode a message comprising the second routing address to be assigned.

The communication module 4 having re-emitted the first predefined value via the point-to-point connection 3a and perceiving by its second point-to-point communication means 4e receives a second predefined value, the communication module 4 records the second routing address to be assigned. Note that the second predefined value is the default value.

A first predefined value is emitted by the communication module 4 by its second point-to-point communication means 4e.

As the second point-to-point communication means 4e is not connected to a point-to-point connection and to another module, it cannot receive a response. At the end of a predetermined duration, having received no response, the emission of the second predefined value on the point-to-point connection 3a is controlled, indicating that there is no other neighbour after the communication module 4.

The interface module 2 receives the second predefined value via the point-to-point connection 3a and stops the neighbour detection method for the point-to-point connection 3a.

The neighbour detection step was described between an interface module 2 and a communication module 4. However, the same step is applied when different modules are involved.

It should be noted that in the case where several devices are connected to a communication module, a routing address can be assigned to the communication module for each connected device. Thus, the communication module can have several routing addresses. The neighbour detection step is repeated several times for the same module for each device connected to said module.

More specifically, the communication module connected to several devices emits in return the first predefined value via the point-to-point connection through which a first predefined value was received as long as the communication module has not received a sufficient number of routing addresses to store one for each device.

More specifically, the first predefined value emitted via the point-to-point connection in return is emitted again after the reception on the series connection of a new routing address until each device connected to the communication module is associated with a routing address.

Then, the communication module resumes the detection of neighbours by its second point-to-point communication means, as described above.

The neighbour detection step described above is applied to all interconnected modules, that is to say as long as the interface module 2 periodically receives the first predefined value via the point-to-point connection.

The neighbour detection step generalised to a larger number of modules will now be described with reference to FIG. 2.

When connected, none of the modules shown in Figure have a routing address. Therefore, they cannot communicate through messages requiring a routing address.

To overcome this, the detection step is carried out from the interface module 2.

The interface module 2 is assigned a first routing address of the decentralised communication system 1. Then, the interface module 2 is controlled to emit by its first point-to-point communication means 2b the first value predefined via the point-to-point connection 31a

The communication module 40 receives the first predefined value on the point-to-point connection 31a. It emits the first predefined value in return via the point-to-point connection 31a.

The interface module 2 receives the first predefined value through the point-to-point connection 31a and deduces from this that the neighbour discovery step should continue and that a routing address should be emitted.

A second routing address is determined and the interface module 2 is controlled to emit by the series connection 31b a message in broadcast mode comprising the second routing address.

Since the message comprising the second routing address is emitted on the series connection 31b, it is read by each of the connected modules, regardless of their discovery by the interface module 2.

The communication module receives the message in broadcast mode comprising the second routing address via the series connection 31b.

Since the second point-to-point communication means of the communication module 40 perceives the default value equal to the second predefined value, the module stores the routing address to be assigned.

The second point-to-point communication means of the communication module 40 emits the first predefined value via the point-to-point connection 32a

The routing module 8 then receives the first predefined value via the point-to-point connection 32a and emits the first predefined value in return via the point-to-point connection 32a. The communication module 40 receives the first predefined value through the point-to-point connection 31a. Since it already has a routing address it emits, in turn, the first predefined value through its other point-to-point connection 31a. The first predefined value is thus retransmitted gradually to the interface module 2.

The interface module 2 receives the first predefined value through point-to-point connection 31a and deduces from this that another module should receive a routing address.

The interface module 2 then determines a third routing address and then emits on the series connection 31b a new message in broadcast mode comprising the third routing address.

The routing module 8 having re-emitted in return the first predefined value via the point-to-point connection 32a and perceiving the second predefined value on its second point-to-point communication means, then it records the third routing address received on the series connection 31b in the message in broadcast mode.

The last module having memorised a routing address emits by its second point-to-point communication means the first predefined value.

Upon receiving the first predefined value in return, the last module having memorised a routing address and all the modules connected up to the interface module 2 gradually retransmit the first predefined value.

Each time the first predefined value is received, the interface module 2 generates a new routing address, and emits a new message in broadcast mode, each comprising a new routing address. The routing address thus generated and emitted is stored by the discovered module.

When the last module in the network is discovered and has stored a routing address, the last module emits the first predefined value by its second point-to-point communication means. As described in the description of the network discovery illustrated by FIG. 1, the second point-to-point communication means is not connected to a point-to-point connection and to a module. It cannot therefore receive a response. After a predetermined duration, having received no response, the emission of a second predefined value is controlled by the first point-to-point communication means of the last discovered network module and having stored an address. The second predefined value is retransmitted gradually by each module until the interface module 2.

Upon receiving this second predefined value by the interface module 2, it is determined that all the connected modules have a routing address and that the gradual discovery of the modules is complete. The interface module 2 is controlled so that it does not determine a new routing address and the neighbour detection step is completed.

In a particular embodiment, each time a first predefined value is received via the point-to-point connection 31a, the interface module 2 stores the assigned routing address in a routing table.

It should be noted that in the particular case of coordination or switching modules, the data processing means comprised in such modules is configured to deterministically transmit the first predefined value received via the point-to-point connection connected to the first point-to-point communication means. Deterministic transmission means that the messages received by such modules via the point-to-point connection connected to the first point-to-point communication means are transmitted in a predetermined order in each branch connected by another point-to-point connection at the output of the module. The predetermined order does not change from one neighbour determination step to the next.

In the case of the coordination module 8 illustrated in FIG. 2, each first predefined value received as input is transmitted by the second point-to-point connection 33a.

All the first values received by the second point-to-point connection 33a are also retransmitted by the first point-to-point connection 32a.

When a second predefined value is received by the second point-to-point connection 33a, it is determined that all the modules in the branch have been detected and have received a routing address. The coordination module 8 is then controlled to emit the first predefined value via the third point-to-point connection 34a.

The coordination module 8 is then controlled to retransmit all the first values received by the fourth point-to-point connection 34a by the first point-to-point connection 32a.

All the first values received by the third point-to-point connection 34a are also retransmitted by the first point-to-point connection 32a.

When a second predefined value is received by the third point-to-point connection 34a, it is determined that all the modules in the branch have been detected and have received a routing address. The coordination module 8 is then controlled to emit the first predefined value by the fourth point-to-point connection 35a.

The coordination module 8 is then controlled to retransmit all the first values received by the fourth point-to-point connection 35a through the first point-to-point connection 32a.

All the first values received by the fourth point-to-point connection 35a are also retransmitted by the first point-to-point connection 32a.

When a second predefined value is received by the fourth point-to-point connection 35a, it is determined that all modules in the branch have been detected, and have received a routing address, and that all branches have been detected.

The coordination module 8 is then controlled to emit a second predefined value by the first point-to-point connection 32a.

In the above example, the coordination module proceeds to discover its branches by successively scanning the second point-to-point connection 33a, then the third point-to-point connection 34a, then the fourth point-to-point connection 35a. However, other branch scan orders are possible while remaining within the scope of the present description.

The selective transmission of predefined values by the coordination or switching module combined with the emission of routing addresses by the interface module allows to discover and assign a routing address to all connected modules.

The data can then be routed by messages as defined in this description.

The neighbour discovery step described above is illustrated in the context of an exchange of messages in the form of either a first predefined value or a second predefined value. These values can be for example structured messages or signal voltage values on the point-to-point connection.

However, in order to speed up message exchanges and therefore speed up network discovery, the messages can be concatenated.

Thus, in the case illustrated by FIG. 1, the first point-to-point communication means 2b of the interface module 2 brings the point-to-point connection 3a to a first level. When the first point-to-point communication means of the communication module 4 perceives the first level on the point-to-point connection 3a and the message in broadcast mode comprising the routing address on the series connection 3b, it records the routing address.

The first point-to-point communication means 2b of the interface module 2 maintains the first level for a predetermined duration after the emission of a message in broadcast mode comprising a routing address. If at the end of this predetermined duration, it still perceives the first level by its first point-to-point communication means 2b, it interprets it as the presence of a module having memorised the routing address comprised in the message emitted in broadcast mode.

During the emission of the third routing address, the communication module 4 does not maintain the first level via its first point-to-point communication means 4b after the predetermined duration following the emission of the message in broadcast mode.

The second level is perceived by its first point-to-point communication means 2b. It interprets it as the absence of a module that has memorised the routing address comprised in the message emitted in broadcast mode. The network discovery is then interrupted.

The network discovery was described above as part of a first discovery of the network in connection with the assignment of routing addresses. However, network discovery can be performed again later in order to verify, for example, that previously discovered modules are still connected or have not undergone a failure, that a new module has been added or replaced or that the first discovery of the network has not been properly performed.

To achieve such a subsequent discovery, the discovery and addressing method described above is applied, omitting the generation of a routing address, the emission of a routing address on the series connection and the storage of the routing address by the last module discovered.

Referring to FIG. 2, the subsequent discovery step comprises the following sub-steps.

The interface module 2 is controlled to emit by its first point-to-point communication means 2b the first predefined value via the point-to-point connection 31a

The communication module 40 receives the first predefined value on the point-to-point connection 31a. It emits the first predefined value in return via the point-to-point connection 31a.

The interface module 2 receives the first predefined value through the point-to-point connection 31a and deduces from this that a module has been discovered.

The second point-to-point communication means of the communication module 40 emits the first predefined value via the point-to-point connection 32a

The routing module 8 then receives the first predefined value via the point-to-point connection 32a and emits the first predefined value in return via the point-to-point connection 32a. The communication module 40 receives the first predefined value through the point-to-point connection 31a. As has already been discovered, it emits, in turn, the first predefined value through its other point-to-point connection 31a. The first predefined value is thus transmitted gradually to the interface module 2.

The interface module 2 receives the first predefined value via the point-to-point connection 31a and deduces from this that another module has been discovered.

The last module having been discovered emits via its second point-to-point communication means the first predefined value.

Upon receiving the first predefined value in return, the last module having memorised a routing address and all the modules connected up to interface module 2 gradually retransmit the first predefined value.

Each time the first predefined value is received, the interface module 2 determines that a new module has been discovered.

When the last module in the network is discovered, it emits the first predefined value by its second point-to-point communication means. As described in the description of the network discovery illustrated in FIG. 1, the second point-to-point communication means is not connected to a point-to-point link and to a module. It cannot therefore receive a response. After a predetermined duration, having received no response, the emission of a second predefined value is controlled by the first point-to-point communication means of the last discovered network module and having stored an address. The second predefined value is retransmitted gradually by each module up to the interface module 2.

Upon receiving this second predefined value by the interface module 2, it is determined that all connected modules have been discovered.

The interface module 2 is thus able to compare the number of discovered modules with the number of modules discovered during the first step of discovery and assignment of routing addresses.

It is also possible to determine the presence of a fault in a connection or in a module by comparing the last module of the network and/or of each branch discovered during the subsequent discovery of the network with the last module of the network and/or of each branch discovered during the initial network discovery and module addressing. If the last module discovered is different from the last module discovered during the initial discovery of the network and the addressing of the modules, it is determined that the point-to-point connection between the last module discovered during the subsequent discovery and the immediately following module is faulty or the immediately following module is faulty. It is thus possible to identify the position of this fault in the topology of the network when the discovery step is carried out from the same module as that from which the first step of discovery and assignment of routing addresses was carried out.

The neighbour discovery step described above is performed by the interface module 2. However, this step and more generally, the control method can be performed by any module of the communication system 1. The decentralised communication system 1 and the method for controlling such a system allow the communication of a memory with devices of a complex system. These devices can be actuators, batteries, power supplies, sensors, emitters, memories of data processing means and more generally any system allowing the operation of a complex system.

1. A decentralised communication system in a robot comprising at least two modules, each module being connected to at least one neighbouring module by a point-to-point connection, all the modules being connected to each other by at least one series connection, each module being selected from at least one interface module (2) or one communication module (4),
an interface module (2) being connected by a connection other than the series connection or the point-to-point connection to at least one memory (5) allowing communication between the memory and the at least one other module,
a communication module (4) being connected by a connection other than the series connection or the point-to-point connection to at least one device (7) allowing communication between the at least one device and the at least one other module,
a device (7) being selected from at least one actuator, a sensor, a communication means, a battery, a power supply or a data processing means.

2. The system according to claim 1, wherein each module comprises at least two first communication means each capable of being connected to a point-to-point connection and at least one series communication means connected to a series connection, the communication means being connected to at least one data processing means.

3. The system according to claim 1, wherein a module is a coordination or switching module configured to connect at least three modules in parallel, each module being connected by a point-to-point connection and a series connection,
the coordination module being configured to retransmit predefined values received over a point-to-point connection according to predefined rules,
the switching module being configured to retransmit messages received over a series connection to at least one other series connection and predefined values received over a point-to-point connection to at least one other point-to-point connection according to predefined rules.

4. A method for controlling a decentralised communication system according to claim 1, wherein the communication system comprises a first module and at least a second module connected to the first module, at least one message is transmitted comprising a preamble (P) and a header (H) between at least two modules of the communication system by carrying out the following steps:
the series communication means of the first module is controlled so as to activate its emission mode while keeping the reception mode activated,
the first module is controlled so as to emit the preamble (P) and at least part of the header (H) via the series connection,
the series communication means of each second module is controlled so as to prohibit the emission mode upon reading at least part of the header,
it is determined via the first module whether another message is emitted by a series communication means of at least a second module in a time interval comprised between the start of the emission of the preamble (P) and the end of the emission of the header (H),
if this is the case, it is considered that the message must not be read by the at least a second module and must be re-emitted by the first module,
if this is not the case, the first module is controlled so as to emit the rest of the message via the series connection,
when the entire message is transmitted, the series communication means of the first module is controlled so as to activate its reception mode and deactivate its emission mode and the series communication means of each second module is controlled so as to cancel the prohibition of the emission mode.

5. The method according to claim 4, wherein a message comprises at least one of the data (D) and an error check value (CTRL).

6. The method according to claim 4, wherein a neighbour detection is carried out gradually in order to discover at least a second module connected directly or indirectly to a first module and at least one routing address is assigned to each second module connected directly or indirectly to the first module, by carrying out the following steps:
a first routing address is assigned to the first module, then
for each point-to-point connection connected to the first module, the following steps are carried out:
each module connected directly or indirectly, to the first module, one after the other, is controlled so that it performs at least one neighbour detection via the series connection and a point-to-point connection,
each time a neighbour is detected, the detected neighbour module is controlled so that it confirms its presence to the first module via the point-to-point connections, the first module is controlled so that it emits at least one new routing address via the series connection, the neighbouring module is controlled so that it stores the at least one new routing address, and the neighbouring module is controlled so that it performs, in turn, a neighbour detection,
the detection of neighbours is stopped when none of the modules connected directly or indirectly detects a new neighbour.

7. The method according to claim 4, wherein a neighbour detection is carried out gradually in order to discover at least a second module connected directly or indirectly to a first module, by carrying out the following steps:
for each point-to-point connection connected to the first module, the following steps are carried out:
each module connected directly or indirectly, to the first module, one after the other, is controlled so that it performs at least one neighbour detection via the series connection and a point-to-point connection,
each time a neighbour is detected, the detected neighbour module is controlled so that it confirms its presence to the first module via the point-to-point connections, and the neighbouring module is controlled so that it performs, in turn, a neighbour detection,
the detection of neighbours is stopped when none of the modules connected directly or indirectly detects a new neighbour.

8. The method according to claim 6, wherein, when a module is connected to at least two devices, the neighbour discovery step is repeated for each device connected to the module.

9. The method according to claim 6, wherein to carry out neighbour detection by a module having received a first predetermined value by a first point-to-point communication means, the following steps are carried out:
the emission of a first predefined value is controlled by the second point-to-point communication means of the module on the point-to-point connection,
it is determined whether the module receives a predefined value in return by the second point-to-point communication means, for a predetermined duration starting at the instant of emission of the first predefined value by the second point-to-point communication means,
if this is the case and the predefined value is equal to the first predefined value, a neighbouring module is considered to be connected to the other end of the point-to-point connection connected to the module,
if this is not the case, it is considered that no second module is connected to the other end of the point-to-point connection connected to the second point-to-point communication means of the module and a second predefined value is emitted by the first point-to-point communication means.

10. The method according to claim 6, wherein, to confirm its presence to the first module, a module transmits a first predefined value by its first point-to-point communication means, the first predefined value being retransmitted gradually through the modules and point-to-point connections to the first module.

11. The method according to claim 6, wherein, a module being connected to a first point-to-point connection and to a second point-to-point connection, when the module has emitted a first value by the first point-to-point connection within a predefined duration, the module receives a first predefined value by the second point-to-point connection within the predefined duration, it retransmits the first predefined value by the first point-to-point connection.

12. The method according to claim 6, wherein, a module being connected to a first point-to-point connection and to a second point-to-point connection, when the module has emitted a first value by the first point-to-point connection within a predefined duration, the module receives a second predefined value by the second point-to-point connection within the predefined duration, it retransmits the second predefined value by the first point-to-point connection.

13. The method according to claim 6, wherein, when the module is a coordination or switching module, comprising a first point-to-point communication means and at least two second first communication means,
the communication or coordination module is controlled so as to carry out a routing and neighbour detection address assignment for each second point-to-point communication means, the coordination or switching module changing from the second point-to-point communication means upon receiving a second predefined value by the second point-to-point communication means, and,
when the coordination or switching module has received a second predefined value on each of its second first communication means, it transmits the second predefined value by its first point-to-point communication means.

14. The method according to claim 6, wherein it is determined that none of the modules connected directly or indirectly to the first module detects a new neighbour, when the first module receives a second predefined value via the point-to-point connection through which it has emitted the first predefined value.

15. The method according to claim 6, wherein,
when a detection of neighbours and an addressing of the discovered modules are controlled by a first module, then when a subsequent detection of neighbours is controlled by the first module,
the last module discovered during the subsequent detection of neighbours is compared with the last module discovered during the initial detection of neighbours and the addressing of the modules,
it is then determined whether the last module discovered during the subsequent detection of neighbours is different from the last module discovered during the initial detection of neighbours and the addressing of the modules.
